(19) United States
(12) Patent Application Publication
(10) Pub. No.: US 2026/0035078 A1
(43) Pub. Date: Feb. 5, 2026

(54) DEICING FOR ROTOR BLADES WITH ICE DETECTORS

(71) Applicant: Lockheed Martin Corporation, Bethesda, MD (US)

(72) Inventors: Daniel A. Griffiths, Woodbridge, CT (US); Philip J. Alldridge, Jupiter, FL (US); Timothy R. Budd, Stratford, CT (US)

(73) Assignee: Lockheed Martin Corporation, Bethesda, MD (US)

(21) Appl. No.: 18/794,942

(22) Filed: Aug. 5, 2024

(51) Int. Cl. B64D 15/22; B64D 15/14

(52) U.S. Cl. CPC B64D 15/22; B64D 15/14

(57) ABSTRACT

An aircraft includes a rotor blade, ice detectors, and heaters. The rotor blade is configured to be driven to rotate about a hub. The ice detectors are positioned along the rotor blade in zones defined at different locations along the rotor blade. The heaters are disposed along the rotor blade. The heaters are configured to selectively provide heat to any of the zones defined at the different locations along the rotor blade. The controller is configured to activate one or more of the heaters to provide targeted heating to one or more of the zones responsive to feedback obtained from the ice detectors.

### FIELD

The present application relates generally to rotor blade assemblies for a rotary wing aircraft and de-icing.

### BACKGROUND

Rotor blade assemblies can, in certain environmental conditions, become partially or completely coated with ice. Heaters may be used to periodically de-ice the blade to remove ice from the rotor blade assemblies.

### SUMMARY

One implementation of the present disclosure relates to an aircraft including a fuselage, an engine, a rotor blade, ice detectors, and heaters, according to some embodiments. In some embodiments, the fuselage includes a hub to rotate relative to the fuselage. In some embodiments, the engine drives the hub to rotate. In some embodiments, the rotor blade is coupled with the hub and includes multiple zones disposed spanwise along the rotor blade. In some embodiments, one or more of the zones have a first value of length spanwise that is greater than a second value of length spanwise of another of the zones. In some embodiments, the ice detectors are positioned along the rotor blade. In some embodiments, each of the zones include at least one of the ice detectors. In some embodiments, the heaters are disposed along the rotor blade. In some embodiments, the heaters are configured to selectively provide heat to any of the zones. In some embodiments, each of the zones include at least one of the heaters. In some embodiments, the controller is configured to activate one or more of the heaters to provide targeted heating to one or more of the zones responsive to feedback obtained from the ice detectors without providing heat to another one of the one or more zones.

In some embodiments, activating one or more of the heaters includes activating one or more of the heaters corresponding to one or more of the zones at which an icing condition is detected. In some embodiments, activating the one or more of the heaters includes maintaining one or more others of the heaters in a de-activated state corresponding to one or more others of the zones at which the icing condition is not detected.

In some embodiments, the values of the length spanwise of the zones decrease along a length of the rotor blade from a first end of the rotor blade at the hub to a second end at a tip of the rotor blade. In some embodiments, the ice detectors are configured to measure icing conditions at surfaces of the rotor blade at the plurality of zones by measuring resistance values at the rotor blade.

In some embodiments, the ice detectors are positioned on a leading edge of the rotor blade. In some embodiments, the zones have non-uniform lengths spanwise. In some embodiments, the first value of the length spanwise of a first zone proximate to the hub about which the rotor blade is configured to rotate is larger than the second value of the length spanwise of a second zone proximate to a tip of the rotor blade.

In some embodiments, activating the one or more of the heaters includes delaying an activation time until an amount of ice has built on the rotor blade at the one or more of the zones, and activating the one or more of the heaters responsive to the amount of ice building up on the rotor blade at the one or more of the zones.

Another implementation of the present disclosure relates to a method of de-icing an aircraft having a rotor blade including zones defined along a length of the rotor blade, heaters corresponding to the zones, and ice detectors corresponding to the zones. In some embodiments, the method includes detecting an icing condition at a first zone of the zones based on feedback from the ice detectors. In some embodiments, the method includes activating a corresponding one of the heaters to provide heat to the rotor blade at the first zone of the zones at which the icing condition is detected. In some embodiments, one or more of the zones have a first value of lengthwise spanwise that is greater than a second value of the length spanwise of another one of the zones.

In some embodiments, the method includes detecting, at a second of the zones, that an icing condition has not occurred based on feedback from the ice detectors. In some embodiments, the method includes maintaining a corresponding one of the plurality of heaters for the second of the zones in a de-activated state while activating the corresponding one of the heaters to provide heat to the first zone.

In some embodiments, activating the corresponding one of the heaters to provide heat to the rotor blade at the first of the zones provides targeted localized heating to the first of the zones at which the icing condition is detected based on localized sensor data from a corresponding one of the ice detectors at the first of the zones. In some embodiments, the zones are defined discretely along a length of the rotor blade from a first end of the rotor blade at a hub about which the rotor blade is configured to rotate to a second end at a tip of the rotor blade.

In some embodiments, the ice detectors are configured to measure icing conditions at surfaces of the rotor blade at the zones by measuring resistance values at the rotor blades. In some embodiments, the ice detectors are positioned on a leading edge of the rotor blade.

In some embodiments, the zones have non-uniform lengths spanwise. In some embodiments, the first value of the length spanwise of the first zone proximate to a hub about which the rotor blade is configured to rotate is larger than the second value of the length spanwise of a second zone proximate to a tip of the rotor blade. In some embodiments, activating the one or more of the heaters includes delaying an activation time until an amount of ice has built on the rotor blade at the one or more of the zones, and activating the one or more of the heaters responsive to the amount of ice building up on the rotor blade at the one or more of the zones.

Another implementation of the present disclosure relates to a de-ice system for an aircraft having a rotor blade, according to some embodiments. In some embodiments, the de-ice system includes ice detectors, heaters, and a controller. In some embodiments, the ice detectors are to be locally disposed along the rotor blade at zones defined along the rotor blade. In some embodiments, one or more of the zones have a first value of length spanwise that is greater than a second value of the length spanwise of another one of the zones. In some embodiments, the heaters are disposed along the rotor blade at the zones. In some embodiments, the heaters are independently operable to selectively provide heating to the rotor blade at the zones. In some embodiments, the controller is configured to operate the heaters independently of each other based on sensor data obtained from the ice detectors to provide targeted heating to zones of the rotor blade at which ice conditions are detected.

In some embodiments, the zones have non-uniform lengths spanwise. In some embodiments, the first value of the length spanwise of a first zone proximate to a hub of the rotor blade is larger than the second value of the length spanwise of a second zone proximate to a tip of the rotor blade.

In some embodiments, the controller is configured to delay activation of the heaters to provide targeted heating to the zones of the rotor blade at which the ice conditions are detected once a predetermined thickness of ice has formed on the rotor blade. In some embodiments, the zones are defined discretely along a length of the rotor blade from a first end of the rotor blade at a hub about which the rotor blade is configured to rotate to a second end at a tip of the rotor blade.

### BRIEF DESCRIPTION OF THE DRAWINGS

The disclosure will become more fully understood from the following detailed description, taken in conjunction with the accompanying Figures, wherein like reference numerals refer to like elements unless otherwise indicated, in which:

FIG. 1 is a side view of a first aircraft, according to an exemplary embodiment;

FIG. 2 is a perspective view of a second aircraft, according to an exemplary embodiment;

FIG. 3 is a diagram of a de-icing system for the aircraft of FIG. 1 or the aircraft of FIG. 2, according to an exemplary embodiment;

FIG. 4 is a block diagram of the de-icing system of FIG. 3, according to an exemplary embodiment;

FIG. 5 is a diagram of a rotor blade illustrating different zones and corresponding ice detectors and heaters, according to an exemplary embodiment;

FIG. 6 is a perspective view of a rotor blade illustrating multiple heaters within each zone and ice detectors positioned proximate to a leading edge, according to an exemplary embodiment; and

FIG. 7 is a flow diagram of a process of locally detecting ice conditions and providing targeted heating to portions of a rotor blade, according to an exemplary embodiment.

It will be recognized that the Figures are schematic representations for purposes of illustration. The Figures are provided for the purpose of illustrating one or more implementations with the explicit understanding that the Figures will not be used to limit the scope of the meaning of the claims.

### DETAILED DESCRIPTION

Following below are more detailed descriptions of various concepts related to, and implementations of, methods, apparatuses, and for providing de-icing for a rotor. The various concepts introduced above and discussed in greater detail below may be implemented in any of a number of ways, as the described concepts are not limited to any particular manner of implementation. Examples of specific implementations and applications are provided primarily for illustrative purposes.

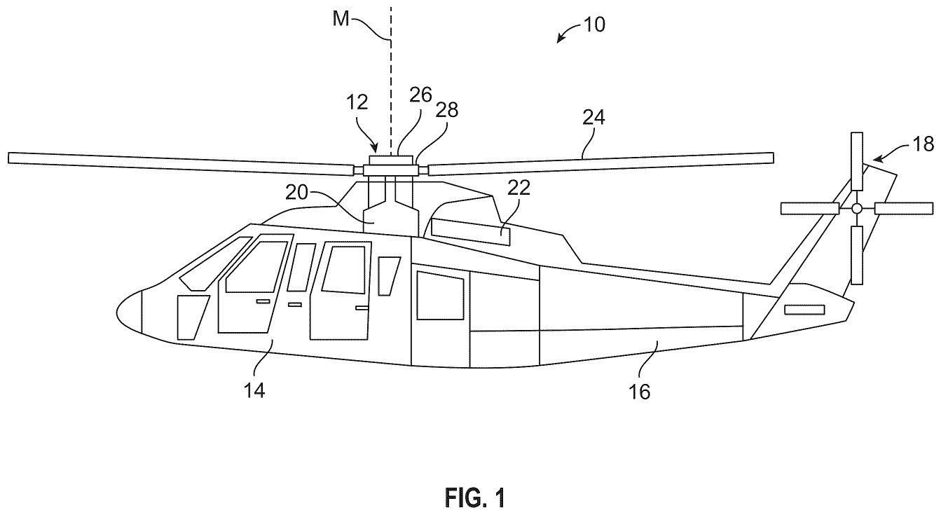

FIG. 1 is perspective view of a rotary wing aircraft 10. In some embodiments, the aircraft 10 or a rotor blade 24 thereof may include one or more features described in U.S. Pat. Nos. 10,899,440 and 10,648,340, which are incorporated by reference herein in their entireties for the rotary structures and techniques described therein.

FIG. 1 depicts a rotary wing aircraft 10 (e.g., an airframe, an aircraft, a rotorcraft, etc.) having a main rotor assembly 12. The aircraft 10 includes an airframe 14 having an extending tail 16 which mounts an anti-torque system, such as a tail rotor assembly having tail rotor blades 18. The main rotor assembly 12 is driven about a rotor axis of rotation M through a transmission 20 by one or more engines 22. The main rotor assembly 12 includes a plurality of rotor blades 24 mounted to a rotor hub 26, and a swashplate 28 that is used to affect a state or orientation of the rotor blades 24. The rotor blades 24 can have a variable pitch that can be used to affect pitch and roll angles of the aircraft 10 as well as velocity of the aircraft 10. The pitch of the rotor blades 24 can be controlled by a collective control or by a cyclic control.

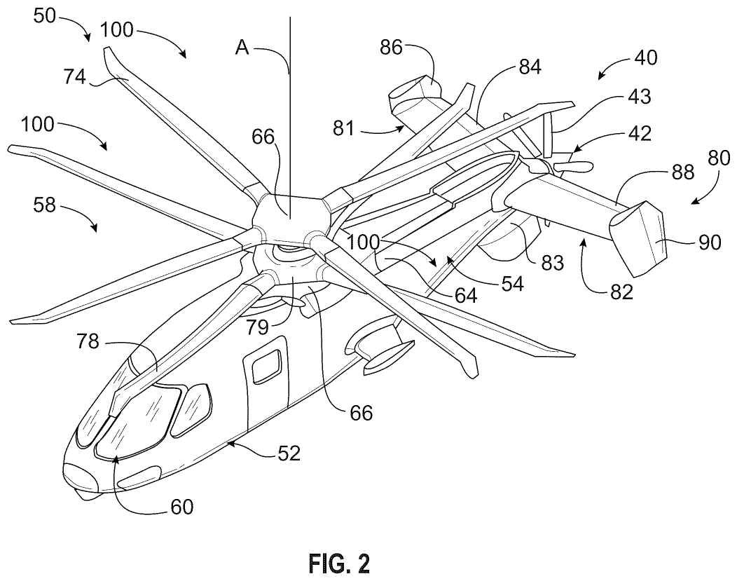

FIG. 2 is a perspective view of another rotary wing aircraft, in accordance with some embodiments. More particularly, FIG. 2 depicts an exemplary aircraft as shown and described in U.S. Pat. No. 11,370,532, the disclosure of which is incorporated by reference herein in its entirety for the overall aircraft system shown therein and construction thereof. FIG. 2 depicts an exemplary embodiment of a rotary wing, vertical takeoff and landing (VTOL) aircraft 50. Aircraft 50 includes an airframe or fuselage 52 having a plurality of surfaces with an extending tail 54. A coaxial main rotor assembly 58 is located at the fuselage 52 and rotates about a main rotor axis, A. In an exemplary embodiment, the fuselage 52 includes a cockpit 60 having seats for flight crew (e.g., pilot and co-pilot) and passengers. Main rotor assembly 58 is driven by a power source, for example, one or more engines 64, via a gearbox 66. Main rotor assembly 58 includes an upper rotor assembly 100 that may be driven in a first direction (e.g., counterclockwise) about the main rotor axis, A, and a lower rotor assembly 100 that may be driven in a second direction (e.g., clockwise) about the main rotor axis, A, opposite to the first direction (i.e., counter rotating rotors). Upper rotor assembly 100 includes a first plurality of rotor blades 74 supported by a first or upper rotor hub 66. Lower rotor assembly 100 includes a second plurality of rotor blades 78 supported by a second or lower rotor hub 79.

In some embodiments, aircraft 50 may include a translational thrust system 40 having a propulsor assembly 42 or a propeller located at extending tail 54 to provide translational thrust (forward or rearward) for aircraft 10. Propulsor assembly 42 includes a plurality of propulsor blades 43. Although a particular aircraft configuration is illustrated in this non-limiting embodiment, other configurations may be employed (e.g., although the dual rotor system is depicted as coaxial, embodiments include dual rotor aircraft having non-coaxial rotors). Propulsor assembly 42 or translational thrust system 40 is connected to and driven by the engine 64 via the gearbox 66. In accordance with another aspect of an exemplary embodiment, extended tail 54 includes a tail section 80 including starboard and port horizontal stabilizers 81 and 82. Tail section 80 further includes a vertical stabilizer 83 that extends downward from extending tail 54. Starboard horizontal stabilizer 81 includes a starboard active elevator 84 and a starboard active rudder 86. Similarly, port horizontal stabilizer 82 includes a port active elevator 88 and a port active rudder 90. Elevators 84 and 88 and rudders 86 and 90 act as controllable surfaces, e.g., surfaces that alter a flight path/characteristics of aircraft 50.

### De-icing System With Localized Control

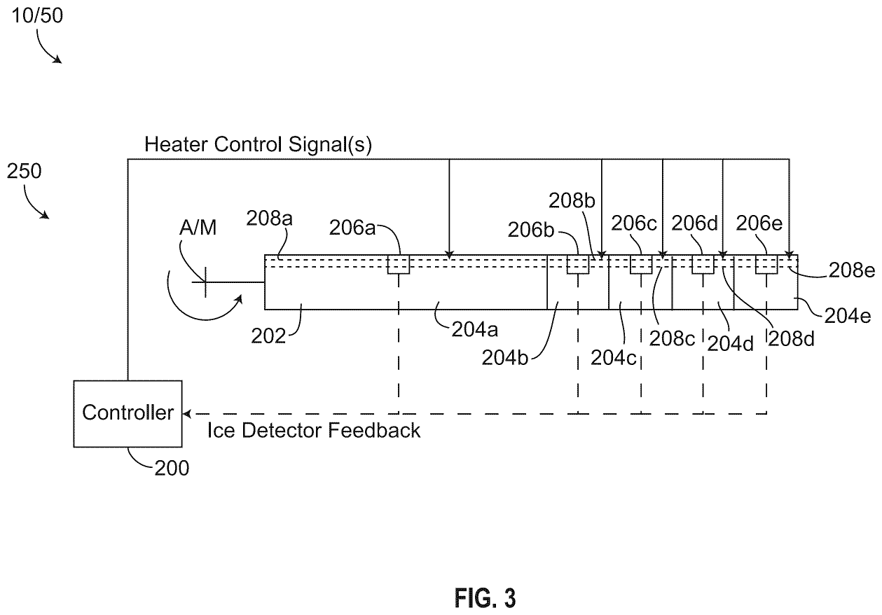

Referring to FIG. 3, a de-icing system 250 is configured to provide targeted de-icing to zones (e.g., portions, sections, areas, etc.) of a rotor blade 202. The rotor blade 202 may be any of the rotor blades 74, the rotor blades 78, or the rotor blades 24 as described in greater detail above with reference to FIGS. 1-2. The de-icing system 250 may be provided on the rotor blades 24 of the aircraft 10, on the rotor blades 74 and 76 of the aircraft 50, or on rotor blades of any other aircraft, helicopter, etc., including rotor blades. The de-icing system 250 may also be provided on fixed-wing or rotatable wing aircrafts. The de-icing system 250 may be configured to provide de-icing for any number of rotor blades 202. The de-icing system 250 may be usable on any helicopter or rotary blade aircraft including, but not limited to, an S-92 helicopter, an H-60 helicopter, an X2 style aircraft such as the Raider® aircraft, etc. The rotor blades 202 may be substantially the same as or similar to a variety of rotor blades such as the main rotor blades 24 of FIG. 1, rotor blades 74 of FIG. 2, rotor blades 78 of FIG. 2, or the tail rotor blades 18 of FIG. 1.

The de-icing system 250 advantageously facilitates localized detection of ice formation on the rotor blade 202 and providing targeted heat to portions of the rotor blades 202 that have sufficient ice formation. When heat is provided to the rotor blade 202 at areas or zones where ice has formed and been detected, a bond between the ice and an exterior surface of the rotor blade 202 may be melted, and the centrifugal force of the rotor blade 202 may cause the ice to be flung (e.g., removed) from the rotor blade 202.

The de-icing system 250 includes multiple ice detectors 206 that are positioned along the rotor blade 202 and heater 208 (e.g., electric heating elements, resistive heating elements, electrothermal heating elements, etc.). The ice detectors 206 are positioned locally on the rotor blade 202. The ice detectors 206 are configured to measure (e.g., detect, sense, etc.) the presence of ice. The ice detectors 206 may be positioned on a leading edge of the rotor blade 202. The ice detectors 206 include a first ice detector 206a positioned in a first zone 204a of the rotor blade 202, a second ice detector 206b positioned in a second zone 204b of the rotor blade 202, a third ice detector 206c positioned in a third zone 204c of the rotor blade 202, a fourth ice detector 206d positioned in a fourth zone 204d of the rotor blade 202, and a fifth ice detector 206e positioned in a fifth zone 204e of the rotor blade 202. It should be understood that the number of five zones 204a-204e and five ice detectors 206a-206e are illustrative only, and that the de-icing system 250 may include any number of ice detectors 206 and the rotor blade 202 may be segmented into any number of zones 204. As shown in FIG. 3, each of the zones 204 includes a single corresponding ice detector 206. In some embodiments, the zones 204 may include more than one ice detector 206. The ice detectors 206 may be conformal ice detectors that conform to an exterior surface of the rotor blade 202. For example, the ice detectors 206 may be coupled (e.g., adhered) directly to an exterior surface of the rotor blade 202. The ice detectors 206 may implement an electrical resistance detection to detect ice formation on the rotor blade 202. For example, the ice detectors 206 can detect ice formation on the rotor blade 202 by measuring a resistance value at the rotor blade 202 without transferring acoustic signals externally along the rotor blade 202. Advantageously, the ice detectors 206 are conformal to the shape of the rotor blade 202 and therefore do not disrupt aerodynamic properties of the rotor blade 202.

The heaters 208a-208e may include multiple heaters that extend lengthwise along the rotor blade 202 (e.g., from a first end proximate to the hub or axis of rotation shown as A/M to a second, distal, end). The heaters 208 are segmented into controllable sections (e.g., independently operable sections) that may be independently activated or de-activated to provide targeted heating to specific ones of the zones 204a-204c. For example, if ice is only detected at the third zone 204c (e.g., by the ice detector 206c), the controller 200 may command activation of the heater 208c for the third zone 204c, while maintaining the other heaters 208a, 208b, 208d, and 208e in an off or de-activated state. In this regard, the de-icing system 250 facilitates efficient use of electrical energy by targeting and activating heating to zones of the rotor blade 202 where ice is detected, and maintaining other heaters where ice is not detected in an off or de-activated state.

The de-icing system 250 is configured to obtain feedback (e.g., sensor data, signals, etc.) from the ice detectors 206a-206e, according to some embodiments. In some embodiments, the de-icing system 250 is configured to detect a presence and location of ice on the rotor blade 202 based on the feedback obtained from the ice detectors 206a-206e. For example, the ice detectors 206a-206e may each provide a signal indicating either that ice is detected or not detected, obtained by the controller 200. Responsive to detection of ice at one of the zones 204, the controller 200 generates and provides control signals to the heaters 208 in order to provide targeted heating to the zone where the ice is detected. The controller 200 may also be configured to implement, in combination with the techniques described herein, any of the ice protection techniques as described in U.S. Pat. No. 10,543,926, the entire disclosure of which is incorporated by reference herein.

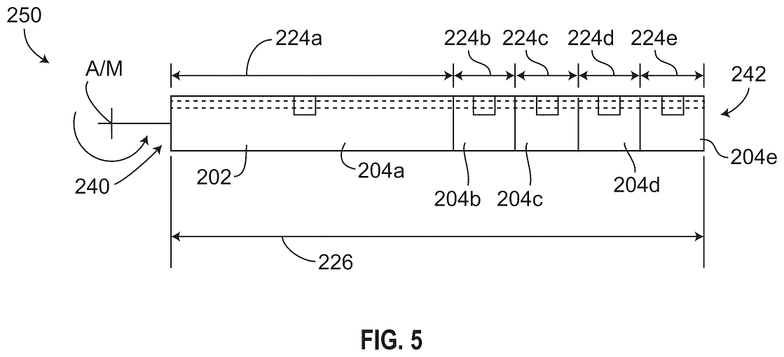

Referring to FIG. 5, the zones 204a-204c may be non-uniform in size. For example, the size of the zones 204 may be defined as a length 224 (e.g., a length in a spanwise direction along the rotor blade 202) of each zone 204 along the rotor blade 202. As shown in FIG. 5, the sizes of the zones 204a-204c (e.g., the lengths spanwise) may decrease along the length of the rotor blade 202 from a first end 240 to a second end 242. The first end 240 is an end of the rotor blade 202 along a spanwise direction at which the rotor blade 202 is coupled with a rotor hub. The second end 242 is a distal or tip end of the rotor blade 202. For example, the size of the zone 204a, most proximate to the first end 240 has a length 224a that is greater than lengths 224b-224e of the zones 204b-204c more proximate to the second end 242. In some embodiments, the sizes of the zones 204a-204e varies along the rotor blade 202 (e.g., each zone has a different size). In some embodiments, one or more subsets of the zones 204a-204e have a uniform size that is different than one or more other subsets of the zones 204a-204c. For example, zones most proximate to the first end 240 may have a largest size, zones in the middle of the rotor blade 202 may have a medium size that is smaller than the largest size, and zones most proximate to the second end 242 may have a smallest size that is smaller than both the largest size and the medium size. In some embodiments, the zones 204a-204e are uniform in size. The zones 204a-204c may be discrete zones for both detection and heating activation defined discretely along the length of the rotor blade 202 (e.g., separate sections defined next to each other along the length of the rotor blade 202). One of more of the zones 204a-204e may be activated in parallel with each other (e.g., at least partially over a same period of time).

In some embodiments, the first zone 204a has length 224a that is substantially 50% of an overall radius or length 226 of the rotor blade 202. In some embodiments, the first zone 204a has length 224a that is 40% to 60% of the overall radius or length 226 of the rotor blade 202. In some embodiments, the zones 204b-204e or any zones further down the rotor blade 202 have lengths (e.g., lengths 224b-224c) that are each substantially 10% of the overall radius or length 226 of the rotor blade 202. In some embodiments, the zones 204b-204e or any zones further down along the rotor blade 202 from the first end 240 have lengths that are each substantially 5% to 15% or 20% of the rotor blade 202. It should be understood that the lengths of the zones 204 described herein are illustrative and are not intended to be limiting, and various sizes of zones 204 may be provided to accommodate different rotor blade designs (e.g., various rotor blades 202 having various lengths and speeds of rotation), and expected environmental conditions. The lengths 224 of the zones 204 may be determined in design and may be a function of expected environmental conditions at various locations along the rotor blade 202 for operating conditions. In particular, the sizes (e.g., the lengths 224) of the zones 204 may be a function of the length 226 of the rotor blade 202 and expected speed of the rotor blade 202.

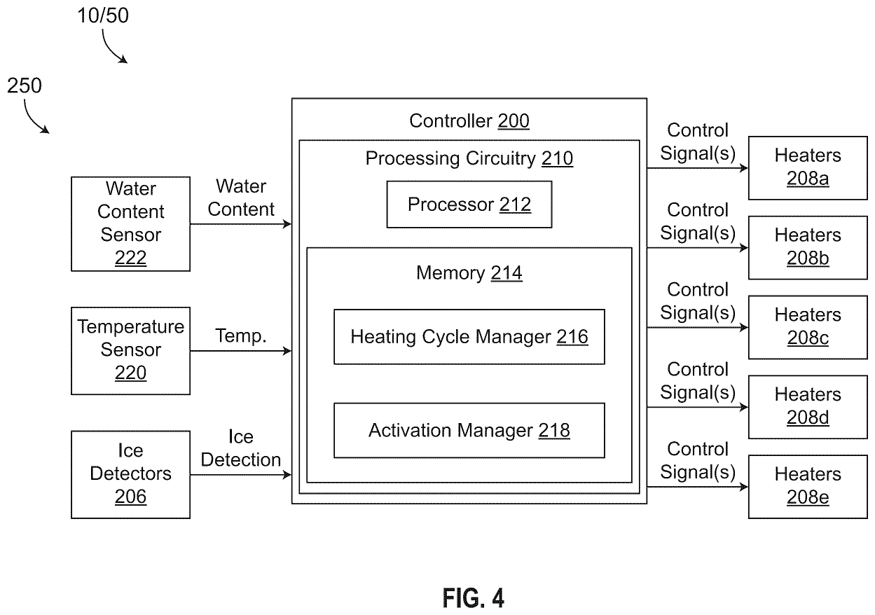

Referring to FIG. 4, the de-icing system 250 is shown in greater detail, according to some embodiments. The de-icing system 250 may further include a water content sensor 222 and a temperature sensor 220. The water content sensor 222 may be a humidity sensor or other sensor configured to measure moisture in the air. The temperature sensor 220 and the water content sensor 222 may be positioned in a fuselage of the aircraft 10 or the aircraft 50.

The controller 200 includes a circuit, shown as processing circuitry 210, a processor, shown as processor 212, and memory, shown as memory 214, according to some embodiments. The controller 200 may be implemented as a general-purpose processor, an application specific integrated circuit (ASIC), one or more field programmable gate arrays (FPGAs), a digital-signal-processor (DSP), circuits containing one or more processing components, circuitry for supporting a microprocessor, a group of processing components, or other suitable electronic processing components. The processing circuitry 210 may include an ASIC, one or more FPGAs, a DSP, circuits containing one or more processing components, circuitry for supporting a microprocessor, a group of processing components, or other suitable electronic processing components (e.g., processor 212). In some embodiments, processing circuitry 210 is configured to execute computer code stored in memory 214 to facilitate the activities described herein.

The memory 214 may be any volatile or non-volatile computer-readable storage medium capable of storing data or computer code relating to the activities described herein. According to an exemplary embodiment, memory 214 includes computer code modules (e.g., executable code, object code, source code, script code, machine code, etc.) configured for execution by processing circuitry 210.

The controller 200 may be provided as separate from (e.g., in terms of operability) other controllers of the aircraft 10 or the aircraft 50. For example, the controller 200 may be stand-alone that operates independently of operation of an aircraft management system or aircraft control system. In some embodiments, the functionality of the controller 200 as described herein is integrated into an aircraft management of the aircraft 10 or the aircraft 50.

Referring still to FIG. 4, the memory 214 includes a heating cycle manager 216 and an activation manager 218, according to some embodiments. In some embodiments, the heating cycle manager 216 is configured to obtain both water content from the water content sensor 222 and temperature from the temperature sensor 220. The temperature may be ambient temperature conditions in the air of the aircraft 10. The water content may be water content conditions in the air of the aircraft 10. The heating cycle manager 216 is configured to obtain the water content and the temperature from the water content sensor 222 and the temperature sensor 220. Based on the water content and the temperature, the heating cycle manager 216 is configured to determine a duty cycle (e.g., a first amount of time to maintain the heaters 208 in an activated state and a second amount of time to maintain the heater 208 in a de-activated state). The heating cycle manager 216 may also be configured to predict, based on the temperature and the water content, a time at which ice formation will occur, and a time at which a specific thickness or amount of ice formation will occur. In some embodiments, the heating cycle manager 216 is configured to determine a time at which to initiate heating of the rotor blade 202. The time at which to initiate heating of the rotor blade 202 may be a time at which a specific amount of ice formation is predicted to occur on the rotor blade 202. In this way, even if ice is initially detected, or conditions in which ice formation will occur are present, the activation of heaters 208 may be delayed until a sufficient mass of ice has formed such that the ice is flung from the rotor blade 202 once an ice-blade bond strength between the ice and the rotor blade 202 has been sufficiently weakened due to operation of the heaters 208.

The activation manager 218 is configured to determine which of the heaters 208a-208e to activate based on the ice detection obtained by the ice detectors 206 (e.g., the ice detectors 206a-206c), according to some embodiments. In some embodiments, the activation manager 218 includes a database of the zones 204a-204e of the rotor blade 202. Responsive to detection of ice at a particular zone (e.g., third zone 204c), the activation manager 218 is configured to determine that the heaters 208c of the third zone 204c should be activated. The activation manager 218 and the heating cycle manager 216 are configured to cooperatively control the heaters 208a-208c in order to provide targeted heat according to the cycle (e.g., the duty cycle, the on-off cycle) as determined by the heating cycle manager 216. The heating cycle manager 216 may cause, after initial detection of ice at one of the zones 204, the corresponding heater 208 to be delayed in activation until a start time such that a predetermined thickness or amount of ice has formed on the rotor blade 202. In some embodiments, the activation manager 218 is configured to activate the heaters 208 immediately in response to detection of ice at one or more zones 204. In some embodiments, the activation manager 218 is configured to activate heaters 208 for zones at which ice is detected but not for zones at which ice is not detected. In this way, the de-icing system 250 may facilitate reduced power consumption by only activating portions of the heaters 208 along the rotor blade 202 at which ice is detected.

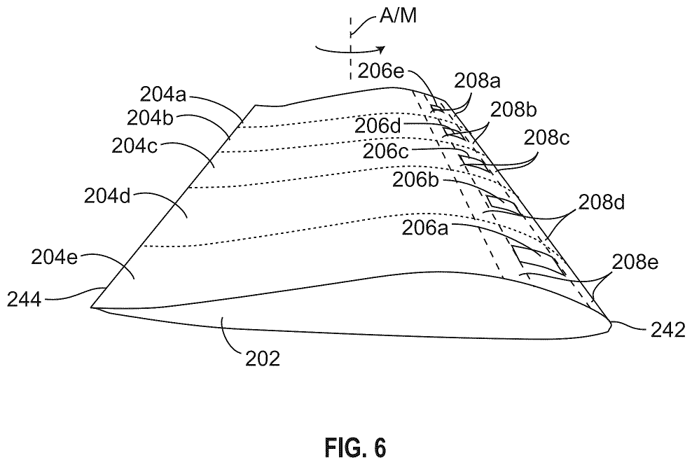

Referring particularly to FIG. 6, the rotor blade 202 is shown to include a leading edge 242 and a trailing edge 244. The ice detectors 206a-206e are positioned at or proximate to the leading edge 242. The ice detectors 206 may be positioned proximate to the leading edge 242 in order to detect ice formation at the leading edge 242. The heaters 208 are disposed along the rotor blade 202 between the leading edge 242 and the trailing edge 244. For example, the heaters 208 include multiple heating elements or members that are disposed in the zones 204. As shown in FIG. 6, each zone 204 includes different members of heating elements 208 in order to provide heating to the rotor blade 202. The strips or lengthwise heating elements 208 may be spaced between the trailing edge 244 and the leading edge 242. In this way, when heating elements 208 of a particular zone (e.g., the third zone 204c) are activated, all of the heating elements 208c in that zone 204c are activated to provide heating to the rotor blade 202 at various locations on the rotor blade 202. In some embodiments, the multiple heating elements 208 of each zone 204 are embedded within the rotor blade 202. For example, the heating elements 208 may be stacked upon each other. The heating elements 208 may extend through an inner volume of the rotor blade 202 such that heat radiates outwards to an exterior surface of the rotor blade 202 when activated. In some embodiments, the zones 204 are otherwise defined or segmented in a direction from the leading edge 242 to the trailing edge 244 and the ice detectors 206 may be positioned at multiple locations within each zone 204 between the leading edge 242 and the trailing edge 244.

The heaters 208 may be positioned on the rotor blade 202 similarly to the configuration of the heating elements distributed chordwise (e.g., chordwise about the rotor blade 202 in a direction perpendicular to the spanwise direction) as described in greater detail in U.S. Pat. No. 10,457,403, the entire disclosure of which is incorporated by reference herein. For example, the heaters 208 may be multiple smaller heating elements positioned on opposite sides of the rotor blade 202 at spanwise positions proximate to the leading edge 242 and/or on the leading edge 242 to provide adequate de-icing. It should be understood that the heaters 208 may be positioned variously about the rotor blade 202 in order to provide de-icing as needed for a particular configuration of a rotor blade and that the description of the positioning of the heaters 208 should not be understood as limiting.

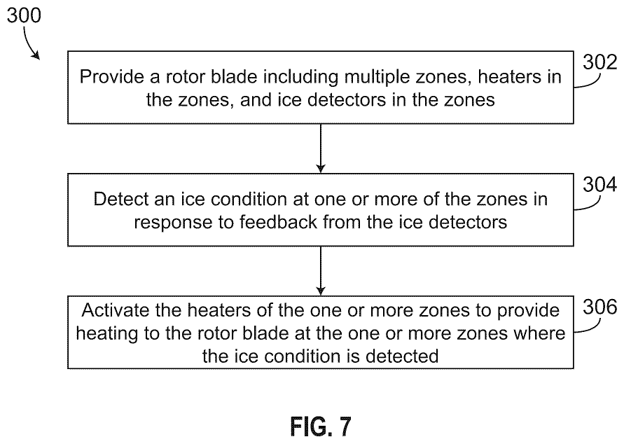

Referring to FIG. 7, a flow diagram of a process 300 for detecting ice on a rotor blade and activating corresponding heaters of the rotor blade includes steps 302-306, according to some embodiments. In some embodiments, the process 300 is performed by the de-icing system 250. The process 300 advantageously facilitates local detection of icing conditions or ice formation on the rotor blade and targeting heat application to the portions or section of the rotor blade to melt a bond between the ice and the exterior surface of the rotor blade.

The process 300 includes providing a rotor blade including multiple zones, heaters in the zones, and ice detectors in the zones (step 302), according to some embodiments. In some embodiments, step 302 includes providing the de-icing system 250 including one or more rotor blades 202 that are drivable to rotate about a hub, various zones defined along the length of the rotor blades 202 (e.g., zones 204), heaters 208, and ice detectors 206. The ice detectors 206 correspond to each of the zones 204 such that ice detection at each zone can be locally identified, according to some embodiments. In some embodiments, the heaters 208 are operable by segments that correspond to the zones 204 such that heating can be applied to each zone 204 of the rotor blade 202 independently.

The process 300 includes detecting an ice condition at one or more of the zones in response to feedback from the ice detectors (step 304), according to some embodiments. In some embodiments, step 304 is performed by the controller 200. For example, the controller 200 may receive sensor signals from the ice detectors 206 indicative of ice formation on the rotor blade 202. Responsive to detection of ice formation at one or more of the zones on the rotor blade 202, the controller 200 may identify portions of the rotor blade 202 that should be provided with heating. In some embodiments, step 304 includes, determining a schedule activation time at which to activate corresponding ones of the heaters 208 and a duration of activation for the heaters 208 based on both water content in the air and environmental temperature.

The process 300 also includes activating the heaters of the one or more zones to provide heating to the rotor blade at the one or more zones where the ice condition is detected (step 306), according to some embodiments. Step 306 may be performed by the controller 200 of the de-icing system 250. In some embodiments, step 306 is performed by activating the heaters 208 of the zones 204 at which ice conditions are detected in step 304. Step 306 may include transitioning heaters 208 of the zones 204 at which ice conditions are detected into active states to provide heating, while maintaining other heaters 208 of the zones 204 at which ice conditions are not detected in a de-activated state in order to provide targeted heating of the rotor blade 202. Advantageously, process 300 provides localized detection of ice conditions on the rotor blade 202 using sensors (e.g., the ice detectors 206) provided locally on the rotor blade 202 (e.g., on the surface of the rotor blade 202) and targeted activation of heaters 208 in order to reduce power consumption required to de-ice the rotor blades 202. Areas of the rotor blade 202 where ice formation is detected may be heated to de-ice the blade until the ice condition is no longer present (e.g., until the ice detectors 206 no longer detect ice formation), while areas that do not have ice formation are not heated to conserve energy.

Referring to FIGS. 3-7, it should be understood that the de-icing system 250 may be configured to implement heating or de-ice control. For example, the heaters 208 may be activated in a targeted manner based on local sensor feedback in order to reduce a likelihood of ice forming on the rotor blades 202 in the first place or to remove ice that has already formed on the rotor blades 202.

Referring still to FIGS. 3-7, the ice detectors 206 may also be used to confirm that there is no ice condition present at various locations of the rotor blade 202. For example, based on speed of the rotor blade 202, the zones 204e at the tip (e.g., the second end 242) may be expected to be above a freezing point of water and therefore expected to not have ice form. The controller 200 may default to not activating the heaters 208e at the second end 242 of the rotor blade 202 but may use feedback from the ice detector 206e to confirm that ice has not formed.

### Configuration of Example Embodiments

While this specification contains specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

When the language “a portion” is used, the item can include a portion and/or the entire item unless specifically stated to the contrary. Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values within the range of values (e.g., W1 to W2 can include only W1 and W2, etc.), unless otherwise indicated.

Unless otherwise indicated, all numbers expressing quantities of properties, parameters, conditions, and so forth, used in the specification and claims are to be understood as being modified in all instances by the term “about.” Accordingly, unless indicated to the contrary, the numerical parameters set forth in the following specification and attached claims are approximations. Any numerical parameter should at least be construed in light of the number reported significant digits and by applying ordinary rounding techniques. The term “about” when used before a numerical designation, e.g., ratios, angles or dimensions for length, radius, width, etc., indicates approximations which may vary by (+) or (−) 10%, 5% or 1%.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow.

1. An aircraft, comprising:
a fuselage including a hub to rotate relative to the fuselage;
an engine to drive the hub to rotate;
a rotor blade coupled with the hub and having a plurality of zones disposed spanwise along the rotor blade, one or more of the plurality of zones having a first value of length spanwise that is greater than a second value of length spanwise of another one of the plurality of zones;
a plurality of ice detectors positioned along the rotor blade on an exterior surface of the rotor blade, the plurality of ice detectors conformed to the exterior surface of the rotor blade, each of the plurality of zones having at least one of the plurality of ice detectors;
a plurality of heaters disposed along the rotor blade, the plurality of heaters configured to selectively provide heat to any of the plurality of zones, each of the plurality of zones having at least one of the plurality of heaters; and
a controller configured to activate one or more of the plurality of heaters to provide targeted heating to one or more of the plurality of zones responsive to feedback obtained from the plurality of ice detectors without providing heat to another one or more of the plurality of zones.

2. The aircraft of claim 1, wherein activating one or more of the plurality of heaters comprises activating one or more of the plurality of heaters corresponding to one or more of the plurality of zones at which an icing condition is detected.

3. The aircraft of claim 2, wherein activating the one or more of the plurality of heaters comprises maintaining one or more others of the plurality of heaters in a de-activated state corresponding to one or more others of the plurality of zones at which the icing condition is not detected.

4. The aircraft of claim 1, wherein values of the length spanwise of the plurality of zones decreases along a length of the rotor blade from a first end of the rotor blade at the hub to a second end at a tip of the rotor blade.

5. The aircraft of claim 1, wherein the plurality of ice detectors are configured to measure icing conditions at surfaces of the rotor blade at the plurality of zones by measuring resistance values at the rotor blade.

6. The aircraft of claim 1, wherein the plurality of ice detectors are positioned on a leading edge of the rotor blade.

7. The aircraft of claim 1, wherein the plurality of zones have non-uniform lengths spanwise, wherein the first value of the length spanwise of a first zone proximate to the hub about which the rotor blade is configured to rotate is larger than the second value of the length spanwise of a second zone proximate to a tip of the rotor blade.

8. The aircraft of claim 1, wherein activating the one or more of the plurality of heaters comprises delaying an activation time until an amount of ice has built on the rotor blade at the one or more of the plurality of zones, and activating the one or more of the plurality of heaters responsive to the amount of ice building up on the rotor blade at the one or more of the plurality of zones.

9. A method of de-icing an aircraft having a rotor blade including a plurality of zones defined along a length of the rotor blade, a plurality of heaters corresponding to the plurality of zones, and a plurality of ice detectors conformed on exterior surfaces corresponding to the plurality of zones, the method comprising:
detecting an icing condition at a first zone of the plurality of zones based on feedback from the plurality of ice detectors conformed to the exterior surfaces; and
activating a corresponding one of the plurality of heaters to provide heat to the rotor blade at the first zone of the plurality of zones at which the icing condition is detected, one or more of the plurality of zones having a first value of length spanwise that is greater than a second value of the length spanwise of another one of the plurality of zones.

10. The method of claim 9, further comprising:
detecting, at a second of the plurality of zones, that an icing condition has not occurred based on feedback from the plurality of ice detectors; and
maintaining a corresponding one of the plurality of heaters for the second of the plurality of zones in a de-activated state while activating the corresponding one of the plurality of heaters to provide heat to the first zone.

11. The method of claim 9, wherein activating the corresponding one of the plurality of heaters to provide heat to the rotor blade at the first of the plurality of zones provides targeted localized heating to the first of the plurality of zones at which the icing condition is detected based on localized sensor data from a corresponding one of the plurality of ice detectors at the first of the plurality of zones.

12. The method of claim 9, wherein the plurality of zones are defined discretely along a length of the rotor blade from a first end of the rotor blade at a hub about which the rotor blade is configured to rotate to a second end at a tip of the rotor blade.

13. The method of claim 9, wherein the plurality of ice detectors are configured to measure icing conditions at surfaces of the rotor blade at the plurality of zones by measuring resistance values at the rotor blade.

14. The method of claim 9, wherein the plurality of ice detectors are positioned on a leading edge of the rotor blade.

15. The method of claim 9, wherein the plurality of zones have non-uniform lengths spanwise, wherein the first value of the length spanwise of the first zone proximate to a hub about which the rotor blade is configured to rotate is larger than the second value of the length spanwise of a second zone proximate to a tip of the rotor blade.

16. The method of claim 9, wherein activating the one or more of the plurality of heaters comprises delaying an activation time until an amount of ice has built on the rotor blade at the one or more of the plurality of zones, and activating the one or more of the plurality of heaters responsive to the amount of ice building up on the rotor blade at the one or more of the plurality of zones.

17. A de-ice system for an aircraft having a rotor blade, the de-ice system comprising:
a plurality of ice detectors to be locally disposed along and conformed to an exterior surface of the rotor blade at a plurality of zones defined along the rotor blade, one or more of the plurality of zones having a first value of length spanwise that is greater than a second value of the length spanwise of another one of the plurality of zones;
a plurality of heaters to be disposed along the rotor blade at the plurality of zones, wherein the plurality of heaters are independently operable to selectively provide heating to the rotor blade at the plurality of zones; and
a controller configured to operate the plurality of heaters independently of each other based on sensor data obtained from the plurality of ice detectors to provide targeted heating to zones of the rotor blade at which ice conditions are detected.

18. The de-ice system of claim 17, wherein the plurality of zones have non-uniform lengths spanwise, wherein the first value of the length spanwise of a first zone proximate to a hub of the rotor blade is larger than the second value of the length spanwise of a second zone proximate to a tip of the rotor blade.

19. The de-ice system of claim 17, wherein the controller is configured to delay activation of the plurality of heaters to provide targeted heating to the zones of the rotor blade at which the ice conditions are detected once a predetermined thickness of ice has formed on the rotor blade.

20. The de-ice system of claim 17, wherein the plurality of zones are defined discretely along a length of the rotor blade from a first end of the rotor blade at a hub about which the rotor blade is configured to rotate to a second end at a tip of the rotor blade.
